(19) United States
(12) Patent Application Publication
(10) Pub. No.: US 2004/0108826 A1
(43) Pub. Date: Jun. 10, 2004

(54) Method for characterizing a rotating electromagnetic machine

(75) Inventor: Charles E.B. Green, St. Louis, MO (US)

Correspondence Address: HOWREY SIMON ARNOLD & WHITE LLP, ATTEN. DOCKETING DEPT. (A), 750 BERING DRIVE, HOUSTON, TX, 77057, US

(73) Assignee: Emerson Electric Co., St. Louis, MO (US)

(21) Appl. No.: 10/248,014

(22) Filed: Dec. 10, 2002

(51) Int. Cl. H02P 5/06

(52) U.S. Cl. 318/254

(57) ABSTRACT

A method of characterizing a rotating electromagnetic machine. The machine, such a switched reluctance machine, has a stator, a rotor and a plurality of phases of energizable windings. The method of characterizing includes turning the rotor, injecting a plurality of diagnostic pulses into at least one of the phase windings, and determining a rotor position profile based on detected characteristics of the diagnostic pulses. A predetermined rotor position profile describing the relationship between diagnostic values and rotor positions may be stored in a memory accessible by the machine's processing device. Diagnostic values corresponding to aligned and unaligned rotor positions for the rotating electromagnetic machine are determined and the predetermined rotor position profile is modified based on the determined diagnostic values corresponding to the aligned and unaligned rotor positions.

### BACKGROUND OF INVENTION

1. Field of the Invention.

The present invention relates generally to rotating machines, and more specifically, to a self-characterizing method for a sensorless rotating machine.

2. Description of Related Art.

In general, a reluctance machine is an electrical machine in which torque is produced by the tendency of its movable part to move into a position where the reluctance of a magnetic circuit is minimized—where the inductance of the exciting winding is maximized. In one type of reluctance machine, circuitry is provided for detecting the angular position of the rotor and energizing the phase windings as a function of the rotor position. This type of reluctance machine is generally known as a switched reluctance machine. It may be operated as a motor or a generator. The characteristics of such switched reluctance machines are well-known and are described in, for example, “The Characteristics, Design and Application of Switched Reluctance Motors and Drives” by Stephenson and Blake, PCIM '93, Nurnberg, Jun. 21-24, 1993, incorporated herein by reference.

The principal components of a typical switched reluctance drive system include a DC power supply, for example, a battery or rectified and filtered AC supply that can be fixed or variable in magnitude. The DC voltage provided by the power supply is switched across the phase windings of the motor by a power converter under the control of an electronic control unit. The switching must be correctly synchronized to the angle of rotation of the rotor for proper operation of the drive. A rotor position detector is typically employed to supply signals indicating the angular position of the rotor. The output of the rotor position detector may also be used to generate a speed feedback signal. Current feedback is provided in the controller by a current transducer that samples current in one or more of the phase windings.

The rotor position detector may take many forms. In some systems, the rotor position detector can comprise a rotor position transducer that provides output signals that change state each time the rotor rotates to a position where a different switching arrangement of the devices in the power converter is required. In other systems, the position detector can be a software algorithm that calculates or estimates the position from other monitored parameters of the drive system. These systems are often called “sensorless position detector systems” since they do not use a physical transducer associated with the rotor that determines the angular position of the rotor. Many different approaches have been adopted in the quest for a reliable sensorless system.

The energization of the phase windings in a switched reluctance machine depends on detection of the angular position of the rotor. When a rotor pole is exactly aligned with a stator pole, the machine is said to be in the aligned position. When current is flowing in the corresponding stator pole winding, there is no torque because the rotor is in a position of maximum inductance and hence minimum magnetic reluctance. If the rotor is rotated out of alignment (in either direction) then a restoring torque urges the rotor back into alignment when current is flowing in the stator pole winding. The stator and rotor are each provided with one or more pairs of poles in opposed relation. Each opposing pair of poles on the stator includes a common winding corresponding to one phase. Various configurations are commonly adopted in switched reluctance machines, for example a three-phase arrangement in which the stator has six poles (three opposed pairs) and the rotor has four poles (two opposed pairs).

For example, as a rotor pole rotates towards a phase winding, the phase winding may be energized as the rotor pole approaches the aligned position and de-energized as the rotor reaches the aligned position. This may be explained by reference to FIGS. 1 and 2, which illustrate the switching of a reluctance machine operating as a motor. FIG. 1 generally shows a rotor 24 with a rotor pole 20 approaching a stator pole 21 of a stator 25 according to arrow 22. As illustrated in FIG. 1, a portion 23 of a complete phase winding is wound around the stator pole 21. When the portion 23 of the phase winding around stator pole 21 is energized, a force will be exerted on the rotor, tending to pull rotor pole 20 into alignment with stator pole 21—towards the maximum inductance position.

FIG. 2 generally shows typical switching circuitry in the power converter that controls the energization of the phase winding, including the portion 23 around stator pole 21. When switches 31 and 32 are closed, the phase winding is coupled to the source of DC power and is energized. Many other configurations of lamination geometry, winding topology and switching circuitry are known in the art: some of these are discussed in the incorporated Stephenson and Blake paper cited above. When the phase winding of a switched reluctance machine is energized in the manner described above, the magnetic field set up by the flux in the magnetic circuit gives rise to the circumferential forces which, as described, act to pull the rotor poles into line with the stator poles.

In general, the phase winding is energized to effect rotation of the rotor as follows. At a first angular position of the rotor (called the “turn-on angle”, T_{ON}), the controller provides switching signals to turn on both switching devices 31 and 32. When the switching devices 31 and 32 are on, the phase winding is coupled to the DC bus, causing an increasing magnetic flux to be established in the machine. The magnetic flux produces a magnetic field in the air gap that acts on the rotor poles to produce the motoring torque. The magnetic flux in the machine is supported by the magneto-motive force (“mmf”), which is provided by a current flowing from the DC supply through the switches 31 and 32 and the phase winding. Current feedback is generally employed and the magnitude of the phase current is controlled by chopping the current by rapidly switching one or both of switching devices 31 and/or 32 on and off. FIG. 3a shows a typical current waveform in the chopping mode of operation, where the current is chopped between two fixed levels. In motoring operation, the turn-on angle T_{ON} is often chosen to be the rotor position where the center-line of an inter-polar space on the rotor is aligned with the center-line of a stator pole, but may be some other angle.

In many systems, the phase winding remains connected to the DC bus (or connected intermittently if chopping is employed) until the rotor rotates such that it reaches what is referred to as the “freewheeling angle” T_{FW} When the rotor reaches an angular position corresponding to the freewheeling angle (the position shown in FIG. 1), one of the switches, for example 31, is turned off. Consequently, the current flowing through the phase winding will continue to flow, but will now flow through only one of the switches (in this example 32) and through only one of the diodes 33/34 (in this example 34). During the freewheeling period, the voltage drop across the phase winding is small, and the flux remains substantially constant. The circuit remains in this freewheeling condition until the rotor rotates to an angular position known as the “turn-off angle” T_{OFF}, (when the center-line of the rotor pole is aligned with that of the stator pole). When the rotor reaches the turn-off angle, both switches 31 and 32 are turned off and the current in phase winding 23 begins to flow through diodes 33 and 34. The diodes 33 and 34 then apply the DC voltage from the DC bus in the opposite sense, causing the magnetic flux in the machine (and therefore the phase current) to decrease. It is known in the art to use other switching angles and other current control regimes.

As the speed of the machine rises, there is less time for the current to rise to the chopping level, and the drive is normally run in a “single-pulse” mode of operation. In this mode, the turn-on, freewheel and turn-off angles are chosen as a function of, for example, speed and load torque. Some systems do not use an angular period of freewheeling—switches 31 and 32 are switched on and off simultaneously. FIG. 3b shows a typical such single-pulse current waveform where the freewheel angle is zero. It is well-known that the values of turn-on, freewheel and turn-off angles can be predetermined and stored in some suitable format for retrieval by the control system as required, or can be calculated or deduced in real time.

Some sensorless position detection systems use diagnostic pulses of some sort that are injected into an idle, or “inactive” phase winding (no phase excitation current applied to the winding). By monitoring the result of these pulses, the control system is able to estimate the rotor position and determine when the main excitation should be applied to and removed from the phase windings. For example, rotor position may be determined by monitoring characteristics associated with the diagnostic pulse, and looking up the rotor position in a stored table having a rotor position profile that correlates values of the monitored characteristic to corresponding values of rotor angle. However, in order for a pre-stored rotor position profile to match a machine's construction well enough to provide accurate rotor position information, machines must be manufactured to precise specifications, typically adding complexity and cost to the manufacturing process.

The present application addresses these and other shortcomings associated with the prior art.

### SUMMARY OF INVENTION

In one aspect of the present invention, a method of characterizing a rotating electromagnetic machine is disclosed. The machine, such a switched reluctance machine, has a stator, a rotor and a plurality of phases of energizable windings. The method of characterizing such a machine includes turning the rotor, injecting a plurality of diagnostic pulses into at least one of the phase windings, and determining a rotor position profile based on detected characteristics of the diagnostic pulses.

Turning the rotor may include energizing the phase windings in some predetermined order to cause the rotor to turn. The rotor may then be allowed to coast and then the diagnostic pulses are injected into an unenergized phase winding. Alternatively, the rotor may be turned by an external mechanical device. Still further, the phase windings may be energized to move the rotor to a desired position, allowing diagnostic values corresponding to the desired rotor position to be determined.

In accordance with further aspects of the present invention, a predetermined rotor position profile correlating diagnostic values with rotor positions is stored in a memory accessible by the machine's processing device. Diagnostic values corresponding to aligned and unaligned rotor positions for the rotating electromagnetic machine are determined and the predetermined rotor position profile is modified based on the determined diagnostic values corresponding to the aligned and unaligned rotor positions. As noted above, the diagnostic values may be determined by injecting diagnostic pulses into the phase windings of the machine. The rotor position profile may be embodied in a look up table that correlates the diagnostic values with rotor positions. In other embodiments, an equation is derived describing the relationship between predetermined values and rotor positions. This equation is then modified based on actual diagnostic values corresponding to the aligned and unaligned rotor positions obtained by diagnosing the machine.

### BRIEF DESCRIPTION OF DRAWINGS

Other objects and advantages of the invention will become apparent upon reading the following detailed description and upon reference to the drawings in which:

FIG. 1 generally illustrates portions of a prior art switched reluctance machine.

FIG. 2 is a circuit diagram illustrating a typical switching arrangement for the power converter of a switched reluctance machine.

FIGS. 3a and 3b are current waveforms illustrating chopping and single-pulse phase energization modes, respectively, for a switched reluctance machine.

FIG. 4 is a block diagram illustrating a switched reluctance machine system in accordance with exemplary embodiments of the present invention.

FIG. 5 is a flow chart generally illustrating a method of characterizing a rotating electromagnetic machine in accordance with aspects of the present information.

FIG. 6 is a plot of current values read from fixed flux linkage diagnostic pulses that vary with a rotating machine's angular position.

FIG. 7 illustrates portions of a switched reluctance machine, showing the rotor in an unaligned position for machine phase “C.”

FIG. 8 illustrates portions of a switched reluctance machine, showing the rotor in an aligned position for machine phase “C.”

FIG. 9 is a flow chart generally illustrating a method of characterizing a rotating electromagnetic machine in accordance with aspects of the present information.

FIGS. 10A and 10B are plots of current versus rotor position based on predetermined data and diagnosed data.

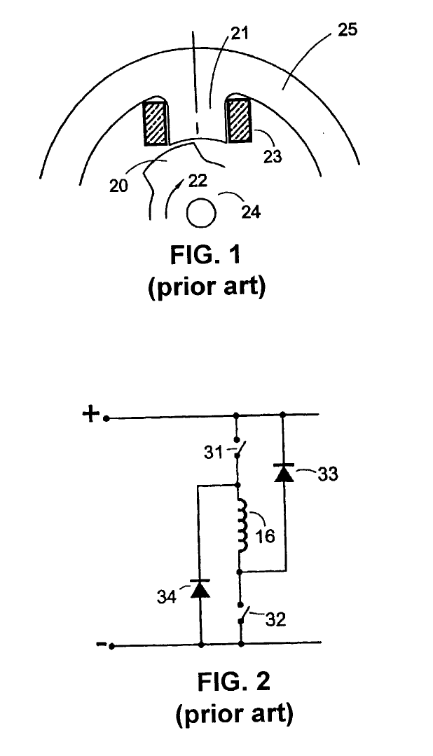

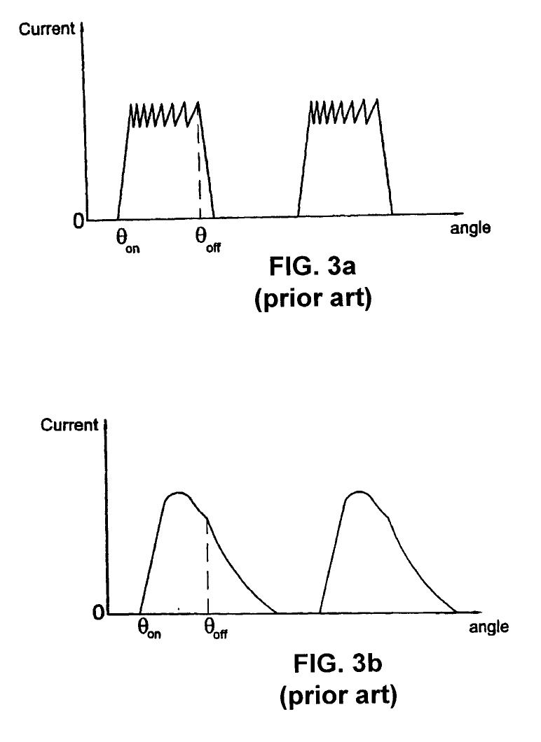

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

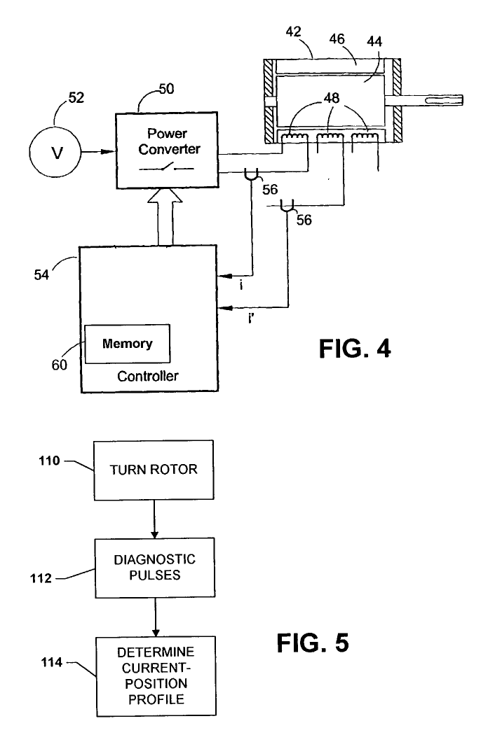

FIG. 4 illustrates a switched reluctance machine employing a sensorless position detector—there is no physical transducer associated with the rotor that determines the angular position of the rotor. The switched reluctance machine 42 includes a rotor 44 mounted to rotate in a stator 46. The illustrated reluctance machine 42 is a polyphase machine—it has three phase windings 48 that are separately energizable. The phase windings 48 are connected to a DC power supply 52 via a power converter 50 that is controlled by a controller 54 to selectively apply power to the phase windings 48. The input DC power supply 52 can be, for example, a battery or rectified and filtered AC supply and can be fixed or variable in magnitude.

The power converter 50 includes a conventional switch arrangement connected to each phase winding 48. The connection of only two of the windings 48 to the schematically represented switch arrangement 50 is shown in FIG. 4 for the sake of clarity. In the illustrated embodiment, the controller 54 receives current information (i, i′) from the windings 48 each by means of a current sensing device 56, such as a Hall-effect device. The controller 54 includes a memory 60 that is accessible by a processing device such as an application specific integrated circuit (ASIC), a properly programmed microprocessor or microcontroller, or a number of discrete chips or analog circuits.

In the illustrated machine, the rotor position is determined by injecting diagnostic pulses into an inactive phase winding. The diagnostic pulses may have, for example, a fixed flux linkage magnitude. The flux linkage is the time integral of the electromotive force (emf) applied to the winding, given by:

φ=∫(V−iR)dt

in which ψ is the flux linkage of the coil, V is the effective supply voltage (less any voltage drops in the power converter 50), i is the coil current and R is the coil resistance.

The current is detected by the current sensing device 56 in each phase winding according to the flux linkage pulses injected. The integration of (V-iR) can be performed in the ASIC according to known methods. Hence, a diagnostic pulse is produced by applying the voltage from the supply 52 and monitoring the increasing value of the integral. When the flux-linkage reaches the predetermined value, the current is recorded and the phase is turned off. The memory 60 stores a rotor position profile that describes the relationship between current values and rotor positions. For example, the memory 60 may include a stored table that correlates current against rotor angle for this fixed flux linkage. The table is accessed to determine the rotor position based on the current value. Alternatively, an equation may be derived that describes the relationship between current and rotor postion.

When the flux-linkage has decayed to zero, a subsequent pulse can be initiated and the process repeated. It will be appreciated that, if the winding resistance R is small, the iR term in the equation can be ignored for practical purposes. The repetition rate of the pulses is a matter of choice for the designer of the system: the pulses can be injected at a fixed frequency or a new pulse can be initiated as soon as the measurement of the previous one is complete and the circuit is ready to begin a new measurement.

Other diagnostic pulse schemes may alternatively be used. For example, a pulse of fixed current height may be used, and the flux-linkage associated with the fixed current is used to determine position from a rotor position profile stored in the memory 60. There are alternative methods of calculating flux-linkage. The integral given in

φ=∫(V−iR)dt

correctly allows for the voltage drops across the switches and for the voltage drop across the resistance of the winding. However, this entails sensing the voltage across each phase winding. In many applications, it is possible simply to integrate the DC link voltage, controlling the integrator by a knowledge of the state of the switches—whether they are on, freewheeling or off—depending on the particular control scheme implemented. This reduces the amount of hardware required, since only one voltage sensor is necessary.

FIG. 5 is a flow chart illustrating a method of characterizing a rotating electromagnetic machine, such as the switched reluctance machine 42 shown in FIG. 4, to develop a rotor position profile for the machine 42. The present disclosure is applicable to other types of sensorless rotating machines though for illustrative purposes, is discussed in conjunction with a switched reluctance machine. As noted above, for a “generic,” or non-machine specific rotor position profile to be useful, the corresponding machine must be manufactured to precise specifications, possibly adding cost and complexity to the manufacturing process.

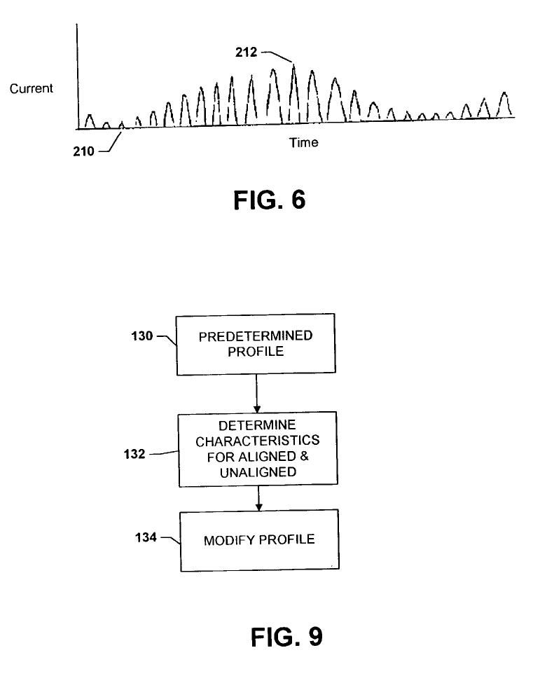

The machine is characterized by turning the rotor (block 110) and injecting diagnostic pulses into at least one of the phase windings 48 (block 112). The rotor position profile for the particular machine 42 is then determined based on detected characteristics of the diagnostic pulses in block 114. For example, the diagnostic pulses may be of a predetermined flux linkage magnitude as described above and thus, the detected characteristic used is the current value corresponding to the fixed flux linkage value. Voltage is applied to a phase winding and ( V-iR) is integrated (or alternatively, only voltage is integrated). When the predetermined flux linkage magnitude is reached, the current is read. As shown in FIG. 6, with the inductance variation caused by the turning rotor, the current will vary. Peaks and troughs indicate the aligned 210 and unaligned 212 positions, respectively.

Turning the rotor is accomplished by any of several methods. For example, the phase windings may be energized in a predetermined order to cause the rotor to turn, and unenergized phase windings are diagnosed. The rotor may be spun up to some predetermined speed, then allowed to coast, leaving the phases free for diagnosing. The rotor may be spun using predetermined rotor position data stored in the look up table. The predetermined data only need to be moderately accurate—enough to allow spinning the rotor in some fashion. In other embodiments, the rotor is turned by some external mechanical means, allowing the phases to be diagnosed at any time.

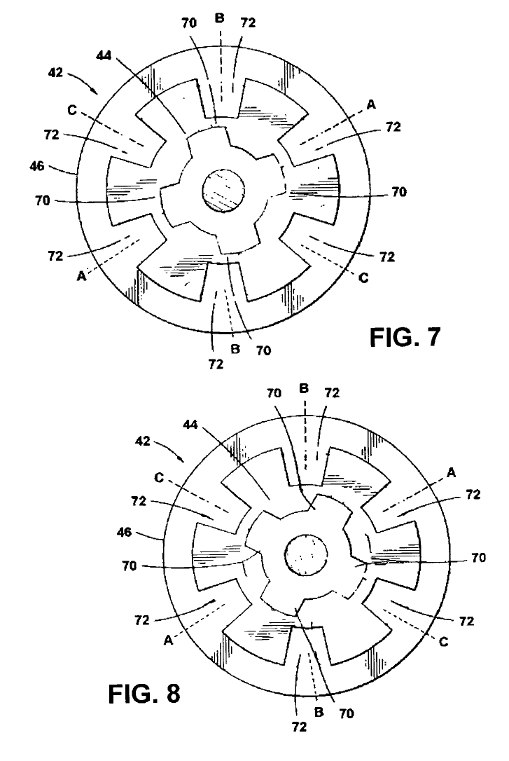

In a three phase machine, such as the machine 42 shown in FIG. 4, the windings of two phases may be simultaneously energized. Referring to FIG. 7, a stator 46 and rotor 44 of an exemplary switched reluctance machine are schematically shown. The rotor 44 includes four rotor poles 70 and the stator includes six stator poles 72. The stator poles 72 are arranged into three sets of opposed pairs corresponding to phases A, B and C. Simultaneously energizing the windings of phases A and B results in the rotor 44 moving to the illustrated position, in which the rotor poles 70 of phase C are completely unaligned with the stator poles 72 of phase C. Diagnostic pulses are then injected into unenergized phase C to determine the current value corresponding to the unaligned position of phase C.

In another embodiment, the windings of two phases are alternately energized to cause the rotor 44 to move back and forth past the unaligned position of the unenergized third phase. Referring again to FIG. 7, alternately energizing phases A and B will cause the rotor 44 to move back and forth past the unaligned position of phase C.

Energizing the windings of a single phase will move the rotor to the aligned position of the energized phase. As shown in FIG. 8, if the windings of only phase C are energized, the rotor 44 will move to position for phase C in which the rotor poles 70 are aligned with the stator poles 72 of phase C. Provided the rotor 44 does not move from this position, phase C can be turned off and immediately diagnosed to determine the current values (assuming fixed flux diagnostic pulses are used) associated with the aligned position.

In accordance with exemplary embodiments of the present invention, a predetermined rotor position profile may be stored in the memory 60 prior to characterizing the machine under consideration. This is illustrated in block 130 of FIG. 9. This predetermined profile is “generic” rotor position profile—not generated based on the particular machine under consideration. For example, the rotor position profile may be embodied by a look up table that correlates diagnostic values, such as current values if fixed flux linkage diagnostic pulses are used, with rotor position information. This initial (predetermined) table typically is only moderately accurate—basically the correct shape—because it is not generated based on the particular machine in which the predetermined table is loaded.

The machine is then characterized as described above to determine the diagnostic values associated with the actual aligned and unaligned rotor positions for the machine under consideration in block 132. The rotor position profile is then scaled (block 134) based on the difference between the predetermined aligned and unaligned rotor values and the actual values determined by characterizing the machine. If desired, this may be done for each phase, allowing a unique profile to be created for each phase.

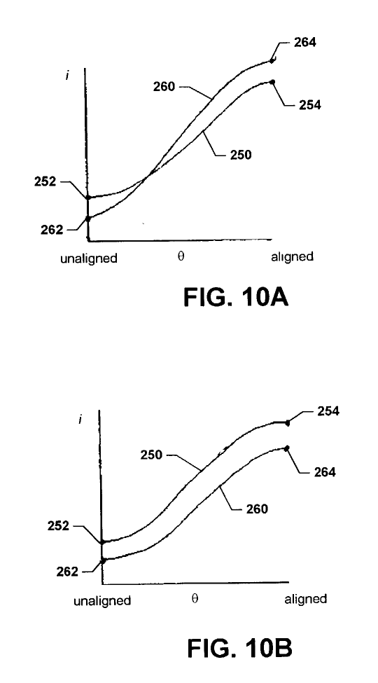

FIGS. 10A and 10B show portions of predetermined rotor position profiles adjusted rotor position profiles based on the diagnosed aligned and unaligned positions. FIGS. 10A and 10B show current values (i) read from fixed flux linkage diagnostic pulses corresponding to rotor position (θ). As noted above, the predetermined profiles need only be moderately accurate, essentially the correct shape. The predetermined profile 250 includes predetermined current values 252, 254 associated with the aligned and unaligned positions, respectively. The adjusted profile 260 scales the curve based on the actual current values 262, 264 associated with the actual aligned and unaligned positions determined based on the diagnostic values obtained while characterizing the machine.

As noted above, the rotor position profile may comprise a look up table correlating diagnostic values with rotor position information. In other embodiments, an equation may be derived to describe the relationship between diagnostic values and rotor position. A first equation may be derived based on predetermined data, and then adjusted based on data obtained via characterization of the machine, resulting in an equation specific to a particular machine.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method of characterizing a rotating electromagnetic machine having a stator, a rotor and a plurality of phases of energizable windings, the rotor and stator each defining a plurality of poles extending therefrom, the method comprising:
turning the rotor;
injecting a plurality of diagnostic pulses into at least one of the phase windings; and
determining a rotor position profile based on detected characteristics of the diagnostic pulses.

2. The method of claim 1, wherein injecting the diagnostic pulses includes injecting the diagnostic pulses into unenergized phases.

3. The method of claim 1, wherein turning the rotor includes energizing the phase windings in a predetermined order to cause the rotor to turn, and wherein injecting diagnostic pulses includes injecting diagnostic pulses into an unenergized phase winding.

4. The method of claim 1, wherein turning the rotor includes:
energizing the phase windings to cause the rotor to turn, and
de-energizing the phase windings and allowing the rotor to coast.

5. The method of claim 1, wherein turning the rotor includes turning the rotor by an external mechanical device.

6. The method of claim 1, wherein determining the rotor position profile includes determining the detected characteristics corresponding to an unaligned position of the rotor.

7. The method of claim 6, wherein the electromagnetic machine is a three phase machine, wherein turning the rotor includes energizing the windings of two phases to move the rotor to the unaligned position of the unenergized phase, and wherein the diagnostic pulses are injected into the unenergized phase.

8. The method of claim 7, wherein turning the rotor includes simultaneously energizing the windings of two phases.

9. The method of claim 7, wherein turning the rotor includes alternately energizing the windings of two phases.

10. The method of claim 1, wherein determining the rotor position profile includes determining the detected characteristics corresponding to an aligned position of the rotor.

11. The method of claim 10, wherein turning the rotor includes energizing the windings of a first one of the phases to move the rotor to the aligned position of the first phase, and wherein injecting the diagnostic pulses includes de-energizing the windings of the first phase and then injecting the diagnostic pulses into the first phase.

12. The method of claim 1, wherein injecting the diagnostic pulses comprises injecting diagnostic pulses of a predetermined flux linkage value.

13. The method of claim 12, wherein the detected characteristic is the current value associated with the predetermined flux linkage value.

14. The method of claim 13, wherein determining the inductance profile includes determining current values corresponding to aligned and unaligned rotor positions.

15. The method of claim 14, further comprising adjusting a look up table correlating predetermined current values with the aligned and unaligned positions based on the determined current values.

16. A method of characterizing a rotating electromagnetic machine having a stator, a rotor, a plurality of phases of energizable windings and a processing device controlling application of power to the windings, the method comprising:
storing a predetermined rotor position profile describing the relationship between diagnostic values and rotor positions;
determining diagnostic values corresponding to aligned and unaligned rotor positions for the rotating electromagnetic machine; and
modifying the predetermined rotor position profile based on the determined diagnostic values corresponding to the aligned and unaligned rotor positions.

17. The method of claim 16, wherein determining diagnostic values corresponding to the aligned and unaligned rotor positions for the rotating electromagnetic machine includes injecting diagnostic pulses into an unenergized phase winding.

18. The method of claim 17, wherein injecting the diagnostic pulses comprises injecting diagnostic pulses of a predetermined flux linkage value.

19. The method of claim 17, wherein the diagnostic values comprise detected characteristics of the diagnostic pulses.

20. The method of claim 18, wherein the diagnostic values comprise the current values associated with the predetermined flux linkage value.

21. The method of claim 16, determining diagnostic values includes:
energizing the phase windings in accordance with the predetermined table to cause the rotor to turn;
de-energizing the phase windings and allowing the rotor to coast; and
injecting diagnostic pulses into an unenergized phase winding.

22. The method of claim 16, wherein the electromagnetic machine is a three phase machine, and wherein determining diagnostic values includes:
energizing the windings of two phases to move the rotor to an unaligned position of the unenergized phase; and
injecting diagnostic pulses into the unenergized phase.

23. The method of claim 16, wherein the electromagnetic machine is a three phase machine, and wherein determining diagnostic values includes:
energizing the windings of a first one of the phases to move the rotor to an aligned position of the first phase;
de-energizing the windings of the first phase, and
injecting diagnostic pulses into the first phase.

24. The method of claim 16, wherein the predetermined rotor position profile comprises a table correlating the diagnostic values with rotor positions.

25. The method of claim 16, wherein the predetermined rotor position profile comprises an equation.
